(19) United States
(12) Patent Application Publication
(10) Pub. No.: US 2026/0044452 A1
(43) Pub. Date: Feb. 12, 2026

(54) TARGET CHIP-CONTROLLED DATA PREFETCH FOR ACCELERATOR SHARING

(71) Applicant: International Business Machines Corporation, Armonk, NY (US)

(72) Inventors: Robert J Sonnelitter, III, Bedford Hills, NY (US); Deanna Postles Dunn Berger, Hyde Park, NY (US); Ekaterina M. Ambroladze, Somers, NY (US); Jason D. Kohl, Austin, TX (US); Gregory William Alexander, Pflugerville, TX (US); Michael A. Blake, Wappingers Falls, NY (US)

(21) Appl. No.: 18/800,255

(22) Filed: Aug. 12, 2024

(51) Int. Cl. G06F 12/0862; G06F 12/0844

(52) U.S. Cl. CPC G06F 12/0862; G06F 12/0844; G06F 2212/6028

(57) ABSTRACT

A processor chip includes hardware, multiple processor cores, multiple caches, and an accelerator. The processor chip is configured to receive a prefetch command from an external processor chip. The prefetch command is associated with a request for the external processor chip to utilize the accelerator. The hardware is configured to select one of the multiple caches for storing data that is to be prefetched to facilitate the requested utilization of the accelerator.

### BACKGROUND

The present invention relates generally to computer hardware, processors, and processor chips with in-chip accelerators such as artificial intelligence accelerators (AI accelerators).

### SUMMARY

According to an exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The hardware is configured to select one of the multiple caches for storing data that is to be prefetched to facilitate the requested utilization of the accelerator.

According to another exemplary embodiment, a computer-implemented method includes receiving at a target processor chip (A) a request from another processor chip to utilize an accelerator of the target processor chip and (B) an associated prefetch command to prefetch data to assist with the accelerator utilization. Hardware on the target processor chip selects a cache of multiple caches of the target processor chip to store the prefetch data.

According to another exemplary embodiment, a processor chip includes multiple processor cores, multiple caches, and an interconnect connecting the multiple processor cores and the multiple caches. The processor chip is configured to select a least busy cache of the multiple caches for storing data that is to be prefetched for use on the processor chip.

According to another exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. The processor chip is configured to prefetch the data to the selected cache without moving data in other caches of the multiple caches of the processor chip.

According to another exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. The selected cache determines an install position within the selected cache for storing the data that is to be prefetched. The install position is selected based on minimizing disruption to other workloads utilizing the selected cache.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a processor chip architecture which implements target-chip controlled data prefetch for cache according to at least one embodiment.

FIG. 2 shows a drawer which includes interconnected multiple processor chips according to at least one embodiment having the processor chip architecture shown in FIG. 1.

FIG. 3 shows a mainframe computer according to at least one embodiment which includes multiple drawers having the design shown in FIG. 2.

FIG. 4 is an operational flowchart illustrating a process for organizing data prefetching for on chip use of the data according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

According to an exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The hardware is configured to select one of the multiple caches for storing data that is to be prefetched to facilitate the requested utilization of the accelerator.

In this manner, technical advantages are achieved including that accelerator sharing occurs in a manner that provides less interference for existing workloads operating on the chip. Instead of being controlled by components external to the chip, the data prefetch is controlled by one or more local elements on the chip that is sharing its accelerator. The one or more local elements have access to best information to facilitate best selection of where to place the prefetched data in a manner that reduces or avoids interference with existing workloads operating on the chip. Additionally, computing task performance, e.g., performing inference in an AI task performed by AI accelerator sharing, occurs more quickly by having task-necessary data available nearby and by avoiding stalling of the task compute.

In one or more additional embodiments, a processor chip includes hardware, multiple processor cores, multiple caches, and an accelerator. The processor chip is configured to receive a prefetch command from an external processor chip. The prefetch command is associated with a request for the external processor chip to utilize the accelerator. The hardware is configured to select one of the multiple caches for storing data that is to be prefetched to facilitate the requested utilization of the accelerator. The hardware includes an interconnect that connects the multiple caches and the multiple processor cores to the AI accelerator. The interconnect includes cache-activity monitoring logic that monitors activity levels of the multiple caches. Based on the monitored activity levels of the multiple caches, the interconnect selects the one of the multiple caches for storing the data that is to be prefetched.

In this manner, technical advantages are achieved including that accelerator sharing occurs in a manner that provides less interference for existing workloads operating on the chip. The data prefetch is controlled by logic of a physical circuit that facilitates communication between different physical elements on the chip that is sharing its accelerator. The physical circuit acquires best information and uses same to facilitate selection of where to place the prefetched data in a manner that reduces or avoids interference with existing workloads operating on the chip.

In one or more additional embodiments, a processor chip includes hardware, multiple processor cores, multiple caches, and an accelerator. The processor chip is configured to receive a prefetch command from an external processor chip. The prefetch command is associated with a request for the external processor chip to utilize the accelerator. The hardware is configured to select one of the multiple caches for storing data that is to be prefetched to facilitate the requested utilization of the accelerator. The hardware includes an interconnect that connects the multiple caches and the multiple processor cores to the accelerator. The interconnect includes cache-activity monitoring logic that monitors activity levels of the multiple caches. Based on the monitored activity levels of the multiple caches, the interconnect selects the one of the multiple caches for storing the data that is to be prefetched. The cache-activity monitoring logic determines which cache of the multiple caches is least busy over a first time period. The selected cache for storing the data that is to be prefetched is the least busy cache as determined by the cache-activity monitoring logic over the first time period.

In this manner, technical advantages are achieved including that accelerator sharing occurs in a manner that provides less interference for existing workloads operating on the chip. The data prefetch is controlled by logic of a physical circuit that facilitates communication between different physical elements on the chip that is sharing its accelerator. The physical circuit accesses or obtains cache activity information to use as suitable information to best determine where to place the prefetched data in a manner that reduces or avoids interference with existing workloads operating on the chip.

In one or more additional embodiments, a processor chip includes hardware, multiple processor cores, multiple caches, and an accelerator. The processor chip is configured to receive a prefetch command from an external processor chip. The prefetch command is associated with a request for the external processor chip to utilize the accelerator. The hardware is configured to select one of the multiple caches for storing data that is to be prefetched to facilitate the requested utilization of the accelerator. The cache-activity monitoring logic determines which cache of the multiple caches is least busy over a first time period. The selected cache for storing the data that is to be prefetched is the least busy cache as determined by the cache-activity monitoring logic over the first time period. The cache-activity monitoring logic determining which cache of the multiple caches is least busy over a first time period is based on the cache-activity monitoring logic monitoring at least one member selected from a group consisting of cache accesses, cache misses, and cache installs for the multiple caches, respectively.

In this manner, technical advantages are achieved including that accelerator sharing occurs in a manner that provides less interference for existing workloads operating on the chip. The data prefetch is controlled by one or more local elements that have best information for deciding how and where to place the prefetched data in a manner that reduces or avoids interference with existing workloads operating on the chip. Workload interference is avoided by tapping cache usage data that is available locally on the target chip.

In one or more additional embodiments, a processor chip includes hardware, multiple processor cores, multiple caches, and an accelerator. The processor chip is configured to receive a prefetch command from an external processor chip. The prefetch command is associated with a request for the external processor chip to utilize the accelerator. The hardware is configured to select one of the multiple caches for storing data that is to be prefetched to facilitate the requested utilization of the accelerator. The accelerator is configured to load a prefetch engine into the selected cache to control the prefetching of the data.

In this manner, technical advantages are achieved including that accelerator sharing occurs in a manner that provides less interference for existing workloads operating on the chip. The data prefetch is controlled by one or more local elements that have best information for deciding how and where to place the prefetched data in a manner that reduces or avoids interference with existing workloads operating on the chip. Acceleration of a compute output such as an inferencing result for AI accelerator sharing is obtained.

According to another exemplary embodiment, a computer-implemented method includes receiving at a target processor chip (A) a request from another processor chip to utilize an accelerator of the target processor chip and (B) an associated prefetch command to prefetch data to assist with the accelerator utilization. Hardware on the target processor chip selects a cache of multiple caches of the target processor chip to store the prefetch data.

In this manner, technical advantages are achieved including that accelerator sharing occurs in a manner that provides less interference for existing workloads operating on the chip. The data prefetch is controlled by one or more local elements on the chip that is sharing its accelerator. The local elements have access to best information that helps them determine where to place the prefetched data in a manner that reduces or avoids interference with existing workloads operating on the chip. Additionally, compute task performance, e.g., performing inference for an AI task done via AI accelerator sharing, occurs more quickly by having task-necessary data available nearby so that stalling of the compute is avoided.

According to another exemplary embodiment, a computer-implemented method includes receiving at a target processor chip (A) a request from another processor chip to utilize an accelerator of the target processor chip and (B) an associated prefetch command to prefetch data to assist with the accelerator utilization. Hardware on the target processor chip selects a cache of multiple caches of the target processor chip to store the prefetch data. The hardware includes an interconnect that connects the multiple caches and multiple processor cores of the target processor chip to the accelerator. The interconnect includes cache-activity monitoring logic that monitors activity levels of the multiple caches. Based on the monitored activity levels of the multiple caches, the interconnect selects the one of the multiple caches for storing the prefetch data.

In this manner, technical advantages are achieved including that accelerator sharing occurs in a manner that provides less interference for existing workloads operating on the chip. The data prefetch is controlled by logic of a physical circuit that facilitates communication between different physical elements on the chip that is sharing its accelerator. The physical circuit acquires best information and uses same to facilitate selection of where to place the prefetched data in a manner that reduces or avoids interference with existing workloads operating on the chip.

According to another exemplary embodiment, a computer-implemented method includes receiving at a target processor chip (A) a request from another processor chip to utilize an accelerator of the target processor chip and (B) an associated prefetch command to prefetch data to assist with the accelerator utilization. Hardware on the target processor chip selects a cache of multiple caches of the target processor chip to store the prefetch data. The hardware includes an interconnect that connects the multiple caches and the multiple processor cores to the accelerator. The interconnect includes cache-activity monitoring logic that monitors activity levels of the multiple caches. Based on the monitored activity levels of the multiple caches, the interconnect selects the one of the multiple caches for storing the data that is to be prefetched. The cache-activity monitoring logic determines which cache of the multiple caches is least busy over a first time period. The selected cache for storing the data that is to be prefetched is the least busy cache as determined by the cache-activity monitoring logic over the first time period.

In this manner, technical advantages are achieved including that accelerator sharing occurs in a manner that provides less interference for existing workloads operating on the chip. The data prefetch is controlled by logic of a physical circuit that facilitates communication between different physical elements on the chip that is sharing its accelerator. The physical circuit accesses or obtains cache activity information to use as suitable information to best determine where to place the prefetched data in a manner that reduces or avoids interference with existing workloads operating on the chip.

According to another exemplary embodiment, a computer-implemented method includes receiving at a target processor chip (A) a request from another processor chip to utilize an accelerator of the target processor chip and (B) an associated prefetch command to prefetch data to assist with the accelerator utilization. Hardware on the target processor chip selects a cache of multiple caches of the target processor chip to store the prefetch data. The prefetch data is prefetched to the selected cache. The prefetching includes fetching the data from a computer memory that is external to the processor chip and storing the prefetch data in the selected cache of the processor chip.

In this manner, technical advantages are achieved including that accelerator sharing occurs in a manner that provides less interference for existing workloads operating on the chip. One compute project such as an artificial intelligence project can tap into customized processors distributed throughout multiple processor chips in order to perform the compute task.

According to another exemplary embodiment, a computer-implemented method includes receiving at a target processor chip (A) a request from another processor chip to utilize an accelerator of the target processor chip and (B) an associated prefetch command to prefetch data to assist with the accelerator utilization. Hardware on the target processor chip selects a cache of multiple caches of the target processor chip to store the prefetch data. The accelerator loads a prefetch engine into the selected cache. The loaded prefetch engine controls the prefetching of the data.

In this manner, technical advantages are achieved including that accelerator sharing occurs in a manner that provides less interference for existing workloads operating on the chip. The data prefetch is controlled by one or more local elements that have best information for deciding how and where to place the prefetched data in a manner that reduces or avoids interference with existing workloads operating on the chip. Acceleration of a compute operation output such as an inferencing result for an AI operation that uses AI accelerator sharing is obtained.

According to another exemplary embodiment, a processor chip includes multiple processor cores, multiple caches, and an interconnect connecting the multiple processor cores and the multiple caches. The processor chip is configured to receive a prefetch command from an external processor chip and to select a least busy cache of the multiple caches for storing data that is to be prefetched for use on the processor chip.

In this manner, technical advantages are achieved including that data prefetching for retrieving data that is to be consumed on the processor chip occurs in a manner that provides less interference for existing workloads operating on the chip. The data prefetch is controlled using analysis of the local caches on the chip as best data for helping avoid or reduce the interference with the existing workloads. Additionally, compute task performance, e.g., performing inference for an AI task, occurs more quickly by having task-necessary data available nearby so that stalling of the compute task is avoided.

According to another exemplary embodiment, a processor chip includes multiple processor cores, multiple caches, and an interconnect connecting the multiple processor cores and the multiple caches. The processor chip is configured to receive a prefetch command from an external processor chip and to select a least busy cache of the multiple caches for storing data that is to be prefetched for use on the processor chip. The interconnect includes cache activity monitoring logic that monitors activity levels of the caches. The cache activity monitoring logic is used to determine the least busy cache of the multiple caches for storing the data that is to be prefetched.

In this manner, technical advantages are achieved including that data prefetching for retrieving data that is to be consumed on the processor chip occurs in a manner that provides less interference for existing workloads operating on the chip. The data prefetch is controlled by logic at the chip that where the prefetched data will be used instead of the data prefetch placement being controlled by an external component or agent. The logic accesses or obtains suitable local information to best determine where to place the prefetched data in a manner that reduces or avoids interference with existing workloads operating on the chip.

According to another exemplary embodiment, a processor chip includes multiple processor cores, multiple caches, and an interconnect connecting the multiple processor cores and the multiple caches. The processor chip is configured to receive a prefetch command from an external processor chip and to select a least busy cache of the multiple caches for storing data that is to be prefetched for use on the processor chip. The interconnect includes cache activity monitoring logic that monitors activity levels of the caches. The cache activity monitoring logic is used to determine the least busy cache of the multiple caches for storing the data that is to be prefetched. The cache activity monitoring logic is configured to monitor at least one member selected from a group consisting of cache accesses, cache misses, and cache installs for the multiple caches, respectively, in order to monitor the activity levels of the caches and to select the least busy cache for storing the data that is to be prefetched.

In this manner, technical advantages are achieved including that data prefetching for retrieving data that is to be consumed on the processor chip occurs in a manner that provides less interference for existing workloads operating on the chip. The data prefetch is controlled by logic at the chip that where the prefetched data will be used instead of the data prefetch placement being controlled by an external component or agent. The logic accesses or obtains suitable local information related to cache usage to best determine where to place the prefetched data in a manner that reduces or avoids interference with existing workloads operating on the chip.

According to another exemplary embodiment, a processor chip includes multiple processor cores, multiple caches, and an interconnect connecting the multiple processor cores and the multiple caches. The processor chip is configured to receive a prefetch command from an external processor chip and to select a least busy cache of the multiple caches for storing data that is to be prefetched for use on the processor chip. The selected cache is a virtual L3 cache that shares storage space with an L2 cache of the multiple caches.

In this manner, technical advantages are achieved including that data prefetching for retrieving data that is to be consumed on the processor chip occurs in a manner that provides less interference for existing workloads operating on the chip. This data prefetching placement control is implemented in a chip which optimizes memory space usage by sharing storage space amongst caches of different hierarchy levels.

According to another exemplary embodiment, a processor chip includes multiple processor cores, multiple caches, and an interconnect connecting the multiple processor cores and the multiple caches. The processor chip is configured to receive a prefetch command from an external processor chip and to select a least busy cache of the multiple caches for storing data that is to be prefetched for use on the processor chip. The interconnect is selected from a group consisting of a ring, a bus, and a mesh.

In this manner, technical advantages are achieved including that data prefetching for retrieving data that is to be consumed on the processor chip occurs in a manner that provides less interference for existing workloads operating on the chip. Local interconnect structure on the chip, instead of an external agent or component, includes logic to find a best place on the chip for storing prefetch data to be used on the chip.

According to another exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. The processor chip is configured to prefetch the data to the selected cache without moving data in other caches of the multiple caches of the processor chip.

In this manner, technical advantages are achieved including that accelerator sharing occurs in a manner that provides less interference for existing workloads operating on the chip. The data prefetch is controlled by the target chip that is sharing its accelerator. The target chip stores the prefetched data in a manner that reduces or avoids interference with existing workloads operating on the target chip.

According to another exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. The processor chip is configured to prefetch the data to the selected cache without moving data in other caches of the multiple caches of the processor chip. The accelerator is a member selected from a group consisting of a graphical processing unit (GPU), a field programmable gate array (FPGA), and an application-specific integrated circuit (ASIC).

In this manner, technical advantages are achieved including that accelerator sharing occurs in a manner that provides less interference for existing workloads operating on the chip. The data prefetch is controlled by the target chip that is sharing its accelerator. The target chip stores the prefetched data in a manner that reduces or avoids interference with existing workloads operating on the target chip. The accelerator sharing occurs to access task-specific customized processors so that computes are optimized to reduce power usage and/or to increase compute speed.

According to another exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. The processor chip is configured to prefetch the data to the selected cache without moving data in other caches of the multiple caches of the processor chip. The accelerator is selected from a group consisting of an artificial intelligence accelerator, a compression accelerator, and a graphics accelerator.

In this manner, technical advantages are achieved including that accelerator sharing occurs in a manner that provides less interference for existing workloads operating on the chip. The data prefetch is controlled by the target chip that is sharing its accelerator. The target chip stores the prefetched data in a manner that reduces or avoids interference with existing workloads operating on the target chip. The accelerator sharing occurs to access task-specific customized processors so that computes are optimized to reduce power usage and/or to increase compute speed.

According to another exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. The processor chip is configured to prefetch the data to the selected cache without moving data in other caches of the multiple caches of the processor chip. The selected cache is a virtual L3 caches that shares storage space with an L2 cache of the multiple caches.

In this manner, technical advantages are achieved including that data prefetching for retrieving data that is to be consumed on the processor chip occurs in a manner that provides less interference for existing workloads operating on the chip. This data prefetching placement control is implemented in a chip which optimizes memory space usage by sharing storage space amongst caches of different hierarchy levels.

According to another exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. The processor chip is configured to prefetch the data to the selected cache without moving data in other caches of the multiple caches of the processor chip. The selected cache determines an install position within the selected cache for storing the data that is to be prefetched. The install position is selected based on minimizing disruption to other workloads utilizing the selected cache.

In this manner, technical advantages are achieved including that accelerator sharing occurs in a manner that provides less interference for existing workloads operating on the chip. The data prefetch is controlled by the target chip that has best information for deciding where to place the prefetched data in a manner that reduces or avoids interference with existing workloads operating on the chip and on the local cache that are used for storing the prefetched data.

According to another exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. The selected cache determines an install position within the selected cache for storing the data that is to be prefetched. The install position is selected based on minimizing disruption to other workloads utilizing the selected cache.

In this manner, technical advantages are achieved including that accelerator sharing occurs in a manner that provides less interference for existing workloads operating on the chip. The data prefetch is controlled by the target chip that has best information for deciding where to place the prefetched data in a manner that reduces or avoids interference with existing workloads operating on the chip and on the local cache that are used for storing the prefetched data.

According to another exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. The selected cache determines an install position within the selected cache for storing the data that is to be prefetched. The install position is selected based on minimizing disruption to other workloads utilizing the selected cache. The install position is offset from a most recently used install position of install positions of the selected cache.

In this manner, technical advantages are achieved including that accelerator sharing occurs in a manner that provides less interference for existing workloads operating on the chip. The data prefetch is controlled by the target chip that has best information for deciding where to place the prefetched data in a manner that reduces or avoids interference with existing workloads operating on the chip and on the local cache that are used for storing the prefetched data. A cache algorithm is utilized to find an install position that reduces or avoids interference with existing workloads operating on the selected cache.

According to another exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. The selected cache determines an install position within the selected cache for storing the data that is to be prefetched. The install position is selected based on minimizing disruption to other workloads utilizing the selected cache. The selected cache is a set-associative cache comprising multiple cache sets. The install position is one of the multiple cache sets.

In this manner, technical advantages are achieved including that accelerator sharing occurs in a manner that provides less interference for existing workloads operating on the chip. The data prefetch is controlled by the target chip that has best information for deciding where to place the prefetched data in a manner that reduces or avoids interference with existing workloads operating on the chip and on the local cache that are used for storing the prefetched data. The data prefetch is implemented with storage policies which balance flexibility in block placement and reducing a likelihood of conflict misses.

According to another exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. The selected cache determines an install position within the selected cache for storing the data that is to be prefetched. The install position is selected based on minimizing disruption to other workloads utilizing the selected cache. The accelerator is a member selected from a group consisting of a graphical processing unit (GPU), a field programmable gate array (FPGA), and an application-specific integrated circuit (ASIC).

In this manner, technical advantages are achieved including that accelerator sharing occurs in a manner that provides less interference for existing workloads operating on the chip. The data prefetch is controlled by the target chip that has best information for deciding where to place the prefetched data in a manner that reduces or avoids interference with existing workloads operating on the chip and on the local cache that are used for storing the prefetched data. The accelerator sharing occurs with a circuit that is customized for a specific task so that task computations are performed with less power and/or more quickly.

According to another exemplary embodiment, a processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. The selected cache determines an install position within the selected cache for storing the data that is to be prefetched. The install position is selected based on minimizing disruption to other workloads utilizing the selected cache. The accelerator is configured to load a prefetch engine into the selected cache to control the prefetching of the data.

In this manner, technical advantages are achieved including that accelerator sharing occurs in a manner that provides less interference for existing workloads operating on the chip. The data prefetch is controlled by the target chip that has best information for deciding where to place the prefetched data in a manner that reduces or avoids interference with existing workloads operating on the chip and on the local cache that are used for storing the prefetched data. Acceleration of a compute output such as an inferencing result for an AI task is obtained.

A processor chip includes hardware, multiple processor cores, multiple caches, and an accelerator. The processor chip is configured to receive a prefetch command from an external processor chip. The prefetch command is associated with a request for the external processor chip to utilize the accelerator. The processor chip is configured to select one of the multiple caches for storing data that is to be prefetched to facilitate the requested utilization of the accelerator. An interconnect of the hardware is configured to select one of the multiple caches for storing data that is to be prefetched to facilitate the requested utilization of the accelerator.

The selection is of a least busy cache of the multiple caches. The processor chip is configured to prefetch the data to the selected cache without moving data in other caches of the multiple caches of the processor chip. The selected cache determines an install position within the selected cache for storing the prefetched data. The install position is selected based on minimizing disruption to other workloads utilizing the selected cache.

In this manner, technical advantages are achieved including that accelerator sharing occurs in a manner that provides less interference for existing workloads operating on the chip. The data prefetch is controlled by the target chip that has best information for deciding where to place the prefetched data in a manner that reduces or avoids interference with existing workloads operating on the chip and on the local cache that are used for storing the prefetched data.

Processor chip enhancements have included introducing customized accelerators such as an artificial intelligence (AI) accelerator directly on/within the processor chip. Past processor chips have previously been limited to using their own accelerator—namely, the accelerator on their own chip. Enabling processors to use accelerators on other processor chips provides workloads with greater compute capacity and flexibility, e.g., greater AI capacity and flexibility. The accelerator workload performance benefits from having data cached locally to the accelerator. The accelerator is customized for task-specific purposes (e.g., for AI tasks, compression tasks, graphics tasks, etc.) instead of being a general purpose chip.

For example, an AI accelerator is optimized for the types of matrix and vector multiplication operations used for deep learning. The accelerator is optimized to implement lower precision than a general-purpose chip, because the accelerator does not have to be as ultra-precise as a central processing unit (CPU). Due to the different demands for artificial intelligence, a lower level of granular resolution for the computations is acceptable. Some embodiments of AI accelerators implement approximate computing which facilitates a reduction to bit-formats holding less information than is held during CPU operation. This simplified format dramatically cuts the amount of number crunching needed to train and run an AI model, without sacrificing accuracy. Leaner bit formats also reduce another drag on speed: moving data to and from memory. Embodiments of AI accelerators which use a range of smaller bit formats, including both floating point and integer representations, make running an AI model far less memory intensive. Some embodiments of AI accelerators also include a lay out of components to streamline AI workflows. Because most AI calculations involve matrix and vector multiplication, accelerator architecture in some embodiments features a simpler layout than a multi-purpose CPU. For example, some embodiments include a lay out design which facilitates sending data directly from one compute engine to the next, creating enormous energy savings. An AI accelerator is a specialized hardware component designed to accelerate artificial intelligence and machine learning applications. The AI accelerator is also known as an AI chip, a deep learning processor, or a neural processing unit. These accelerators are built to speed up AI neural networks, deep learning, and machine learning by handling parallelized linear algebra computations.

Other types of processor component structural optimizations are used for other accelerators such as compression accelerators, graphics accelerators, etc.

To improve compute operations, a processor that wants to use an accelerator on another chip sends a special prefetch command to the cache hierarchy that includes a target chip to prefetch the data. This prefetch command is routed to the target chip. On the target chip, the least busy cache on the chip is selected to prefetch the data. A dedicated engine is loaded to prefetch one or more cache lines. These prefetches are processed similarly to prefetches initiated by a core that is local to the cache. Using the techniques described herein, an accelerator that is on a different chip than the requesting processor chip is able to effectively cause the data to be fetched (e.g., pre-fetched) into a cache that is not in its cache hierarchy but is more accessible to the accelerator that is being shared.

Moving the data into the caches on the same chip where the compute takes place improves the ability of the accelerator to perform its task, such as inferencing for an AI task, faster. Because significant data is required by the accelerator to complete a task such as an inference for an AI task, it is important that the accelerator have good access to the data that is needed for the task.

In an AI embodiment, a workload is running and the application encounters a situation requiring a task-specific compute. One core in the system begins a Neural Network Processing Assist workload to engage an AI accelerator. The AI accelerator is also known as an AI engine. The NNPA core is a core whose location may be anywhere in the system, not necessarily on the same chip, module or drawer as the AI accelerator that is performing the inference. The NNPA core will initiate a series of prefetches into the on-chip cache of the AI accelerator, in order to accelerate the obtainment of a result of an AI task such as an inferencing result. The prefetch enables this acceleration by streaming data pages into the on-chip cache such that the data hits on-chip with low latency when the AI accelerator fetches this data. This pre-fetching prevents or helps avoid the AI/inferencing compute from being stalled while waiting for memory access.

Thus, this orderly pre-fetching enables real-time inference results to be achieved despite simultaneously running workloads.

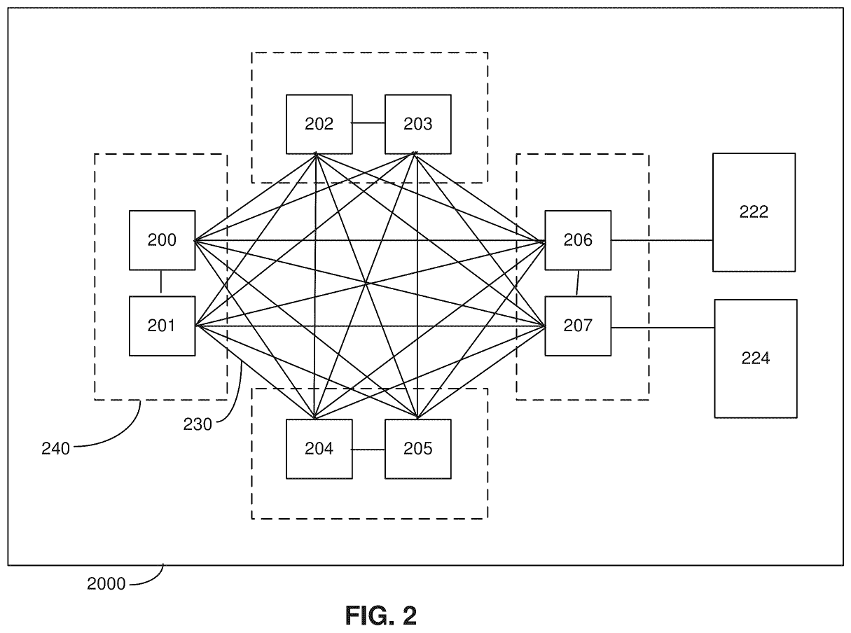

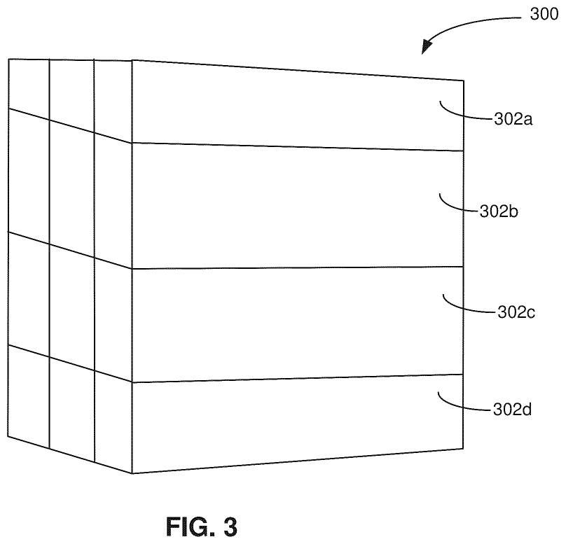

FIG. 2 shows a drawer 2000 which can be part of a mainframe computer (see, e.g., FIG. 3) and which includes interconnected multiple processor chips according to at least one embodiment. The drawer 2000 includes eight interconnected processor chips labeled as 200, 201, 202, 203, 204, 205, 206, and 207, respectively. The eight chips are divided into four pairs, with a first pair 240 being labeled and includes the processor chips 200 and 201. Each of the eight processor chips has a bus connection with the other seven processor chips of this drawer 2000. These bus connections are illustrated in FIG. 2, with a first bus connection 230 being labeled that connects the processor chip 201 and the processor chip 204. The processor chips communicate with computer memory in the drawer such as first memory 222 and second memory 224. FIG. 2 shows the processor chip 206 connected to the first memory 222 and the processor chip 207 connected to the second memory 224. The other processor ships are connected to other computer memories.

FIG. 3 shows a mainframe computer 300 which includes multiple drawers 302a, 302b, 302c, and 302d. Each of these multiple drawers 302a-302d are designed with the drawer architecture shown in FIG. 2, with multiple processor chips in each drawer that are able to communicate with each other via bus connections. The processor chips are also able to communicate with processor chips on other drawers via inter-drawer bus connections.

All or some of the processor chips 200-207 include their own respective accelerator that is located within the respective chip. To facilitate enhanced computing, one processor chip is able to request and use the accelerator of one of the other processor chips. Such sharing request occurs in some instances when the compute operation requires more computing power than is provided by a single accelerator on a single processor chip. When a sharing request occurs, an instruction is also sent to the other chip to prefetch data that will be needed for the compute operation.

The present embodiments provide improved techniques, logic, and structure for organizing the data prefetching that is associated with the accelerator sharing with external chips. To improve compute operations, a processor that wants to use an accelerator on another chip sends a special prefetch command to the cache hierarchy that includes a target chip to prefetch the data. This prefetch command is routed to the target chip. On the target chip, the least busy cache on the chip is selected to prefetch the data. A dedicated engine is loaded to prefetch one or more cache lines. These prefetches are processed similarly to prefetches initiated by a core that is local to the cache. Using the techniques described herein, an accelerator that is on a different chip than the requesting processor chip is able to effectively cause the data to be fetched (e.g., pre-fetched) into a cache that is not in its cache hierarchy but is more accessible to the accelerator that is being shared.

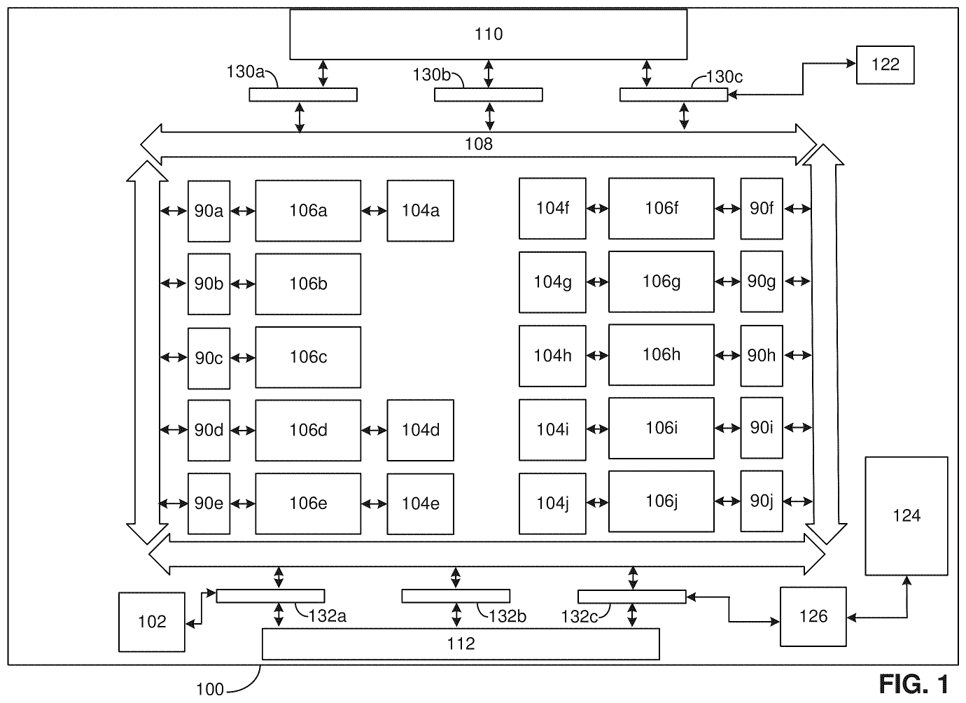

FIG. 1 shows a processor chip 100 which has an architecture that implements target-chip controlled data prefetch according to at least one embodiment. All, some, or at least one of the various processor chips 200-207 shown in FIG. 2 has a processor chip architecture similar to or matching the processor chip 100 as shown in FIG. 1 and as described below. The processor chip 100 includes multiple separate processing cores 104a, 104d, 104e, 104f, 104g, 104h, 104i, and 104j. The processing cores are connected to their own separate caches, e.g., L3 cache. Specifically, processing core 104a is connected to and paired with the cache 106a. Processing core 104d is connected to and paired with the cache 106d. processing core 104e is connected to and paired with the cache 106e. Processing core 104f is connected to and paired with the cache 106f. Processing core 104g is connected to and paired with the cache 106g. Processing core 104h is connected to and paired with the cache 106h. Processing core 104i is connected to and paired with the cache 106i. Processing core 104j is connected to and paired with the cache 106j. A cache is a hardware component on the processor chip that has data storage locations so that the stored data is more easily retrievable. The data stored in a cache is often data generated from an earlier computation or a copy of data that is stored in other memory. The caches are often divided into various hierarchical levels such as L1 caches, L2 caches, and L3 caches. In the depicted embodiment, the caches 106a-106j are L3 caches which are last level caches that are typically larger than L1 and L2 caches but are typically slower for facilitating data retrieval.

The processor chip 100 includes an accelerator 102 which is able to communicate with each of the caches 106a-106j and with each of the processing cores 104a-104j. An interconnect 108 (an on-chip interconnect such as an on-chip ring interconnect, an on-chip bus, an on-chip mesh, etc.) connects and allows communication between the various caches, processing cores, accelerator 102, and other components of the processor chip 100. The interconnect 108 also communicates with fabric 110 which facilitates communication with components that are external to the processor chip 100, such as another processor chip in the same drawer or more specifically an accelerator on another processor chip in the same drawer or in the same mainframe. The interconnect 108 includes stations 130a, 130b, 130c to facilitate communication with the internal caches 106a-106j and processing cores 104a-104j and the fabric 110 and the nest accelerator unit 122. The interconnect 108 includes stations 132a, 132b, 132c to facilitate communication with the accelerator 102, the memory bus 112, the microcontroller unit 124, and the multiple clock domain microprocessor 126.

If a processor chip that is external to the processor chip 100 wants to use the accelerator 102 on the processor chip 100 to assist with a computation task such as an artificial intelligence compute, data that will be used for the task should be sent to the processor chip 100. By placing this data in an accessible position at the processor chip 100, the accelerator 102 easily finds the data to use and exerts fewer power to retrieve the nearby data. The compute process can occur more quickly if the data is nearby. The request for accelerator sharing could, for example, in the drawer 2000 shown in FIG. 2 be done with the processor chip 200 requesting to the processor chip 207 to let the processor chip 200 use the accelerator located on the processor chip 207.

A processing core of the external chip (the share requesting chip) issues a prefetch command that transfers across one or more of the inter-chip buses. When the command arrives at the processor chip 100, the command enters the processor chip 100 via the fabric 110 and then goes into the interconnect 108. The interconnect 108 in at least some embodiments include cache activity monitoring logic that monitors the activity of the caches 106a-106j. The interconnect 108 and the cache activity monitoring logic identify which of the caches 106a-106j is most available to accept the prefetch command. A prefetch engine is loaded into the most available cache. The accelerator 102 is able to access any of the caches 106a-106j. The loaded engine controls the loading of the data into that cache, e.g., by generating and transmitting prefetch commands and controlling the storage of the retrieved (prefetched) data into the appropriately selected cache and install position. For example, the cache 106d is the least busy cache as determined by the cache activity monitoring logic of the interconnect 108. The prefetch engine is loaded into the cache 106d. The prefetch engine fetches data into the cache 106d. This prefetched data will be needed for the compute operation to be performed at the accelerator 102 to assist the external chip that requested use of the accelerator 102. Thus, when the accelerator 102 proceeds with the compute task such as an AI operation the accelerator 102 is readily able to find, access, and retrieve that prefetched data from the nearby location within the cache 106d.

This data will be on the same chip, which is advantageous in time (faster) and computing power considerations (less power consumed) compared to in real-time retrieving the data from another memory of the computer or to memory on another chip to retrieve data.

In at least some embodiments, the interconnect 108 includes cache monitoring activity logic that monitors activities of the caches, e.g., any L3 caches within the same chip, and the interconnect 108 uses that monitoring and data to select which of the local caches is the least active or least busy. A prefetch engine is loaded into that selected cache. The loaded prefetch engine retrieves, e.g., prefetches, the data so that the data is ready for the compute task to be performed by the accelerator 102, e.g., as part of a compute work sharing request from an external chip.

The selected cache, e.g., cache 106d, determines the install position for storing the prefetched data within the cache 106d to minimize disruption to other workloads. In at least some embodiments, one or more of the caches is a set-associative cache. For example, in some embodiments an individual cache has an eighteen-way set-associative cache. Thus, the cache is divided into eighteen different segments for storing different data portions. For any given cache line, the cache line could be installed in one of eighteen positions/places in the cache. When something new is installed into the cache, the cache is likely full so the new install requires replacing something that is already existing/stored in the cache. A set-associative cache can be imagined as a n ×m matrix. The cache is divided into ‘n’ sets and each set contains ‘m’ cache lines. A memory block is first mapped onto a set and then placed into any cache line of the set. The set-associative cache is an intermediary between directly-mapped cache and fully associative cache.

The cache includes an algorithm that determines and decides which of the eighteen entries to choose to replace its stored contents with the new data that is received. One example of such an algorithm is an LRU (Least recently used) algorithm. LRU replaces the data that was accessed least recently. There is a good likelihood that those data lines in the least recently used place have already served their purpose and are no longer needed for present operations at this processor. When a new data line is brought in, then the storage position for the new data line is designated as most recently used. As more data is brought in to a respective cache, cache lines will move from the most-recently-used (MRU) position down to the least-recently-used (LRU) position. Once the data reaches the least-recently-used position, the data will be replaced when the next new data entry comes to the cache. For the present embodiments, instead of installing the prefetched data into the MRU position, the prefetched data is stored in an offset position that is offset from the MRU position. For example in the embodiment with eighteen install positions within a single cache, the prefetched data is stored into the middle, e.g., in position ten (e.g., with the MRU being position “one” and the LRU being position “eighteen”). Thus, the prefetched data will live in the cache for a shorter period of time (until this prefetched data is selected to be replaced by another new incoming data) as compared to the length of time the data would live in the cache if the data had been stored in the MRU position.

These logics/algorithms which decide which individual install position within a cache to use are within the individual cache. The logic makes this determination based on the reason the data is being brought in (e.g., the type of command, which element issued the command, etc.). For processor core requests, those requests would be put into the MRU position so that this data stays in the cache for a longest amount of time. Prefetches for more specialized use such as in accelerator sharing or other types of consumption sharing do not need that length of time in the cache, however, and do not need to live as long in this particular cache. Thus, the present embodiments include storing the prefetch data into a cache and an install position so that the prefetched data is less disruptive to other data and operations occurring in the chip and cache. The prefetching could occur into a cache that a processor core of the same chip is already using, but the prefetching data is brought into a position of the cache-in-use that is not the MRU position. Thus, this control of storage location of storing the data that is prefetched helps avoid interfering with the current cache e.g., L3, operation and other simultaneously running operations on the target chip.

Because these simultaneously running workloads share the same system cache that the accelerator uses, intelligent prefetch install selection helps achieve improved performance for the task (e.g., an AI task) as well as maintain quality performance of other computing tasks being performed by the target chip. In some embodiments, the caches 106a-106j are on-chip “virtual L3” caches. These virtual L3 caches are comprised of ten instances of an L2 cache which are interconnected by the on-chip interconnect. The accelerator workload is fully satisfied with a data hit location in any on-chip cache (virtual L3), e.g., with any of the caches 106a-106j that are on the target chip. However, simultaneously running processor workloads ideally have their data in their L1/L2 caches also on the target chip. Therefore, installing the prefetched data (e.g., for the AI accelerator task) in the virtual L3 cache in one or more L2 locations that are least busy minimizes evictions of processor workload data to make room for the AI accelerator data.

In order to identify the least busy L2 locations on the chip, the hardware on the chip monitors the activity of each individual cache. By comparing the activity of the multiple caches, the hardware selects the least busy cache. In some embodiments, cache activities/events that are monitored include one or more of cache accesses, cache misses, and cache installs. To minimize disruption to a processor workload using the selected cache, within the selected cache the prefetched data is placed in locations that the replacement algorithm of the cache identifies as having not been recently accessed by the processor. In some embodiments to minimize disruption to a processor workload using the selected cache, within the selected cache the prefetched data updates the replacement algorithm of the cache so that the prefetched data will be replaced before data being used by the paired processor is replaced. For a LRU replacement algorithm, for example, one embodiment includes storing the prefetched data in an install position other than the MRU position, such as storing the prefetched data in the N/2 position in a N-way LRU. In one embodiment with multiple install positions and the first install position being the MRU position, the algorithm identifies one or more install positions not accessed within a predetermined time period and stores the prefetched data in the most recent of these install positions. In other embodiments, the algorithm stores the prefetched data in any of these positions (of those not accessed within a predetermined time period), including in other positions that are closer to the LRU position.

Although FIGS. 1-3 show certain numbers of caches, processors, drawers, etc., in other embodiments other numbers of these elements could still be used with the inventive techniques described herein for target chip-controlled data prefetching of data for accelerator sharing.

While the processor chip 100 shown in FIG. 1, the drawer shown in FIG. 2, and the mainframe shown in FIG. 3 are used to provide an illustration of systems in which the processor architecture of the present embodiments is implemented, it is understood that the depicted structure is not limiting and is intended to provide examples of suitable structures in which the techniques of the present embodiments are applied. It should be appreciated that FIGS. 1-3 do not imply any limitations with regard to the structures in which different embodiments may be implemented. Many modifications to the depicted structures may be made based on design and implementation requirements.

In some embodiments, a drawer is provided which at least includes a first drawer comprising a first processor chip and a second processor chip, each of the first processor chip and the second processor chip comprising a respective accelerator, hardware, multiple respective caches, and multiple processor cores. The second processor chip is configured to receive a prefetch command from the first processor chip. The prefetch command is associated with a request for the first processor chip to utilize the accelerator of the second processor chip. The hardware of the second processor chip is configured to select one of the multiple caches on the second processor chip for storing data that is to be prefetched to facilitate the requested utilization of the accelerator. The selection is performed via hardware of the second chip and/or the selection is based on identifying a least busy cache of the multiple caches of the second processor chip and/or the prefetching occurs into a local cache without causing other data stored in other portions of said cache or other caches within the chip to move. The install position within the selected cache is also selected (for storing the prefetched data) to avoid interference with other cache operations.

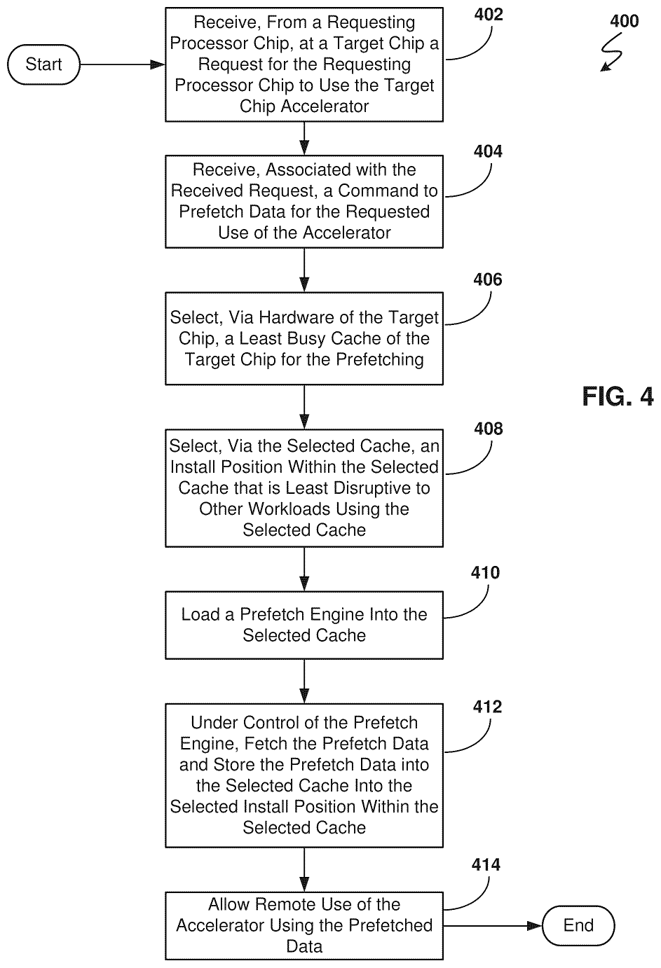

FIG. 4 is an operational flowchart illustrating a target chip-controlled data prefetching process 400 for assisting accelerator sharing according to at least one embodiment. The target chip-controlled data prefetching process 400 may be implemented using the processor chip architecture shown in FIG. 1 and in some embodiments the drawer structure shown in FIG. 2 and/or the mainframe structure show in FIG. 3.

In step 402 of the target chip-controlled data prefetching process 400, a request is received at a target chip. The request is from a requesting processor chip. The request is for the requesting processor chip to use the accelerator of the target chip. In step 404 of the target chip-controlled data prefetching process 400, a command is received at the target chip to prefetch data that is associated with the requested sharing use of the accelerator. In step 406 of the target chip-controlled data prefetching process 400, hardware of the target chip selects a least busy cache of the target chip for the prefetching. In step 408 of the target chip-controlled data prefetching process 400, the selected cache selects an install position within the selected cache. The selected install position is least disruptive to other workloads that are already using the selected cache. In step 410 of the target chip-controlled data prefetching process 400, a prefetch engine is loaded into the selected cache. In step 412 of the target chip-controlled data prefetching process 400, under control of the loaded prefetch engine the prefetch data is fetched and stored in the selected cache. The prefetch data is stored in the selected cache in the selected install position within the selected cache. In step 414 of the target chip-controlled data prefetching process 400, remote use of the accelerator is allowed. This remote use uses the prefetched data. The operation is performed under the sharing arrangement. The data is present on-chip so that low latency occurs when the accelerator fetches this already fetched data. This pre-fetching prevents or helps avoid the compute from stalling while waiting for memory access. Thus, this orderly pre-fetching enables real-time compute results such as an AI inference to be achieved despite simultaneously running workloads.

It may be appreciated that FIG. 4 provides only illustrations of certain embodiments and does not imply any limitations with regard to how different embodiments may be implemented. Many modifications to the depicted embodiment(s) such as to an order of the steps performed may be made based on design and implementation requirements.

The present embodiments allow prefetching of data into a cache that is outside of the cache hierarchy of a processor core. The present embodiments achieve sharing of chip cache memory between an accelerator and other processors. The present embodiments achieve technical advantages of allowing an accelerator to be used on a socket other than where the memory is located. The present embodiments achieve more efficient reuse of on-chip resources.

The flowchart and block diagrams in the Figures illustrate the architecture, functionality, and operation of possible implementations of systems and methods according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor chip comprising:
hardware, multiple processor cores, multiple caches, and an accelerator, wherein:
the processor chip is configured to receive a prefetch command from an external processor chip,
the prefetch command is associated with a request for the external processor chip to utilize the accelerator, and
the hardware is configured to select one of the multiple caches for storing data that is to be prefetched to facilitate the requested utilization of the accelerator.

2. The processor chip of claim 1, wherein:
the hardware comprises an interconnect that connects the multiple caches and the multiple processor cores to the accelerator,
the interconnect comprises cache-activity monitoring logic that monitors activity levels of the multiple caches, and
based on the monitored activity levels of the multiple caches, the interconnect selects the one of the multiple caches for storing the data that is to be prefetched.

3. The processor chip of claim 2, wherein:
the cache-activity monitoring logic determines which cache of the multiple caches is least busy over a first time period, and
the selected cache for storing the data that is to be prefetched is the least busy cache as determined by the cache-activity monitoring logic over the first time period.

4. The processor chip of claim 3, wherein the cache-activity monitoring logic determining which cache of the multiple caches is least busy over a first time period is based on the cache-activity monitoring logic monitoring at least one member selected from a group consisting of cache accesses, cache misses, and cache installs for the multiple caches, respectively.

5. The processor chip of claim 1, wherein the accelerator is configured to load a prefetch engine into the selected cache to control the prefetching of the data.

6. A computer-implemented method comprising:
receiving at a target processor chip:
a request from another processor chip to utilize an accelerator of the target processor chip, and
an associated prefetch command to prefetch data to assist with the accelerator utilization; and
selecting via hardware on the target processor chip a cache of multiple caches of the target processor chip to store the prefetch data.

7. The computer-implemented method of claim 6, wherein:
the hardware comprises an interconnect that connects the multiple caches and multiple processor cores of the target processor chip to the AI accelerator,
the interconnect comprises cache-activity monitoring logic that monitors activity levels of the multiple caches, and
based on the monitored activity levels of the multiple caches, the interconnect selects the cache of the multiple caches for storing the prefetch data.

8. The computer-implemented method of claim 7, wherein:
the cache-activity monitoring logic determines which cache of the multiple caches is least busy over a first time period, and
the selected cache for storing the data that is to be prefetched is the least busy cache as determined by the cache-activity monitoring logic over the first time period.

9. The computer-implemented method of claim 6, further comprising prefetching the prefetch data to the selected cache, wherein the prefetching comprises fetching the data from a computer memory that is external to the processor chip and storing the prefetch data in the selected cache of the processor chip.

10. The computer-implemented method of claim 6, wherein the accelerator loads a prefetch engine into the selected cache and the loaded prefetch engine controls the prefetching of the data.

11. A processor chip comprising:
multiple processor cores, multiple caches, and an interconnect connecting the multiple processor cores and the multiple caches, wherein the processor chip is configured to receive a prefetch command from an external processor chip and to select a least busy cache of the multiple caches for storing data that is to be prefetched for use on the processor chip.

12. The processor chip of claim 11, wherein the interconnect comprises cache activity monitoring logic that monitors activity levels of the caches, and the cache activity monitoring logic is used to determine the least busy cache of the multiple caches for storing the data that is to be prefetched.

13. The processor chip of claim 12, wherein the cache activity monitoring logic is configured to monitor at least one member selected from a group consisting of cache accesses, cache misses, and cache installs for the multiple caches, respectively, in order to monitor the activity levels of the caches and to select the least busy cache for storing the data that is to be prefetched.

14. The processor chip of claim 11, wherein the selected cache is a virtual L3 cache that shares storage space with an L2 cache of the multiple caches.

15. The processor chip of claim 11, wherein the interconnect is selected from a group consisting of a ring, a bus, and a mesh.

16. A processor chip comprising:
hardware, multiple processor cores, multiple caches, and an accelerator, wherein:
the processor chip is configured to receive a prefetch command from an external processor chip,
the prefetch command is associated with a request for the external processor chip to utilize the accelerator,
the processor chip is configured to select one of the multiple caches for storing data that is to be prefetched to facilitate the requested utilization of the accelerator, and
the processor chip is configured to prefetch the data to the selected cache without moving data in other caches of the multiple caches of the processor chip.

17. The processor chip of claim 16, wherein the accelerator is a member selected from a group consisting of a graphical processing unit (GPU), a field programmable gate array (FPGA), and an application-specific integrated circuit (ASIC).

18. The processor chip of claim 16, wherein the accelerator is selected from a group consisting of an artificial intelligence accelerator, a compression accelerator, and a graphics accelerator.

19. The processor chip of claim 16, wherein the selected cache is a virtual L3 cache that shares storage space with an L2 cache of the multiple caches.

20. The processor chip of claim 16, wherein:
the selected cache determines an install position within the selected cache for storing the data that is to be prefetched, and
the install position is selected based on minimizing disruption to other workloads that are utilizing the selected cache.

21. A processor chip comprising:
hardware, multiple processor cores, multiple caches, and an accelerator, wherein:
the processor chip is configured to receive a prefetch command from an external processor chip,
the prefetch command is associated with a request for the external processor chip to utilize the accelerator,
the processor chip is configured to select one of the multiple caches for storing data that is to be prefetched to facilitate the requested utilization of the accelerator,
the selected cache determines an install position within the selected cache for storing the data that is to be prefetched, and
the install position is selected based on minimizing disruption to other workloads that are utilizing the selected cache.

22. The processor chip of claim 21, wherein the install position is offset from a most recently used install position of install positions of the selected cache.

23. The processor chip of claim 21, wherein:
the selected cache is a set-associative cache comprising multiple cache sets, and
the install position is one of the multiple cache sets.

24. The processor chip of claim 21, wherein the accelerator is a member selected from a group consisting of a graphical processing unit (GPU), a field programmable gate array (FPGA), and an application-specific integrated circuit (ASIC).

25. The processor chip of claim 21, wherein the accelerator is configured to load a prefetch engine into the selected cache to control the prefetching of the data.
